(19) United States
(12) Patent Application Publication
(10) Pub. No.: US 2012/0024972 A1
(43) Pub. Date: Feb. 2, 2012

(54) METHOD AND APPARATUS FOR REDUCING CYCLONE INTENSITY

(76) Inventor: Jack Jerome Ellis, Chesterfield, MO (US)

(21) Appl. No.: 12/848,701

(22) Filed: Aug. 2, 2010

(51) Int. Cl. A01G 15/00

(52) U.S. Cl. 239/2.1; 239/14.1

(57) ABSTRACT

Apparatus for reducing intensity of a cyclone over water. The apparatus includes a body having buoyancy sufficient to float in a fluid and a conduit extending from the body into water to an inlet at a depth where the water has a temperature of at least forty degrees Fahrenheit below that of water at the surface. The apparatus includes a pump in fluid communication with the conduit for drawing water from the depth and a sprayer operatively connected to the pump for spraying droplets of water drawn from the depth into air above the water.

### BACKGROUND

The present invention generally relates to a method and apparatus for reducing cyclone intensity, and more particularly to a method and apparatus for reducing the intensity of tropical storms, tropical cyclones, typhoons, and hurricanes over water.

Cyclones produce severe and wide spread destruction and death throughout the world each year. Cyclones occur when air traveling over warm ocean water flows into a low pressure, rotating air mass. The air picks up heat and humidity as it travels over the ocean toward the low pressure area at the center of cyclone. The heated air increases speed and rises as it reaches an eyewall of the cyclone. As the air rises, its pressure drops, cooling the air and causing the water vapor in the air to condense to liquid. The condensed liquid falls to earth as rain. When the ocean temperature is sufficiently warm, the air traveling over the ocean picks up enough heat to substantially increase the wind speed, raising the cyclone intensity to that of a hurricane or typhoon.

Such a cyclone C develops the circulatory pattern illustrated in FIG. 1. Rising air forms an eyewall designated by the character E in FIG. 1. The rising air cools, falling toward a surface S of the water W where it is again heated and rises. The falling air current induces a counter-rotating convective circuit outside the circuit forming the eyewall. Other successively smaller circuits are formed outside the first counter-rotating convective circuit. Warm water temperatures (i.e., temperatures greater than about eighty Fahrenheit at the surface S) feed the convective circuits, strengthening the cyclone C. There is need for an apparatus and method for reducing cyclone intensity to prevent or reduce the strength of cyclones such as hurricanes or typhoons.

### SUMMARY

The present invention relates to apparatus for reducing intensity of a cyclone over water comprising a body having buoyancy sufficient to float in a fluid. The apparatus also includes a conduit extending from the body into water to an inlet at a depth where the water has a temperature of at least forty degrees Fahrenheit below that of water at the surface. A pump is in fluid communication with the conduit for drawing water from the depth. A sprayer operatively connected to the pump for spraying droplets of water drawn from the depth into air above the water.

The present invention also relates to apparatus for reducing intensity of a cyclone over water comprising a body having buoyancy sufficient to float in a fluid and a conduit extending from the body into the water to an inlet at a depth of at least 250 feet. Further, the apparatus includes a pump in fluid communication with the conduit for drawing water from the depth and a sprayer operatively connected to the pump for spraying droplets of water drawn from the depth into the air above the water.

In addition, the present invention includes apparatus for reducing intensity of a cyclone over water. The apparatus comprises a ship having a body adapted to float in water and a propulsion system mounted on the body having power sufficient to move the body through the water at a speed of at least about thirty miles per hour. A conduit extends from the body of the ship into the water to an inlet at a depth of at least 250 feet. The apparatus includes a pump in fluid communication with the conduit for drawing water from the depth and a sprayer mounted on the ship. The sprayer is operatively connected to the pump for spraying droplets of water drawn from the depth into rising air above the water at an eyewall of the cyclone.

Still further, the present invention includes a method for reducing intensity of a cyclone over water comprising drawing water from a depth where the water has a temperature of at least forty degrees Fahrenheit below that of water at the surface and spraying water drawn from the depth into rising air above the water at an eyewall of the cyclone.

Moreover, the present invention includes a method for reducing intensity of a cyclone over water comprising drawing water from a depth of at least 250 feet, atomizing the water drawn from the depth into droplets of a size sufficient to rise with rising air at an eyewall of the cyclone, and introducing the atomized water into rising air above the water at an eyewall of the cyclone.

### BRIEF DESCRIPTION OF THE DRAWINGS

FIG. 1 is a schematic elevation of convective circuits in a cyclone; and

FIG. 2 is a schematic elevation of apparatus of the present invention.

Corresponding reference characters indicate corresponding parts throughout the drawings.

### DETAILED DESCRIPTION OF THE DRAWINGS

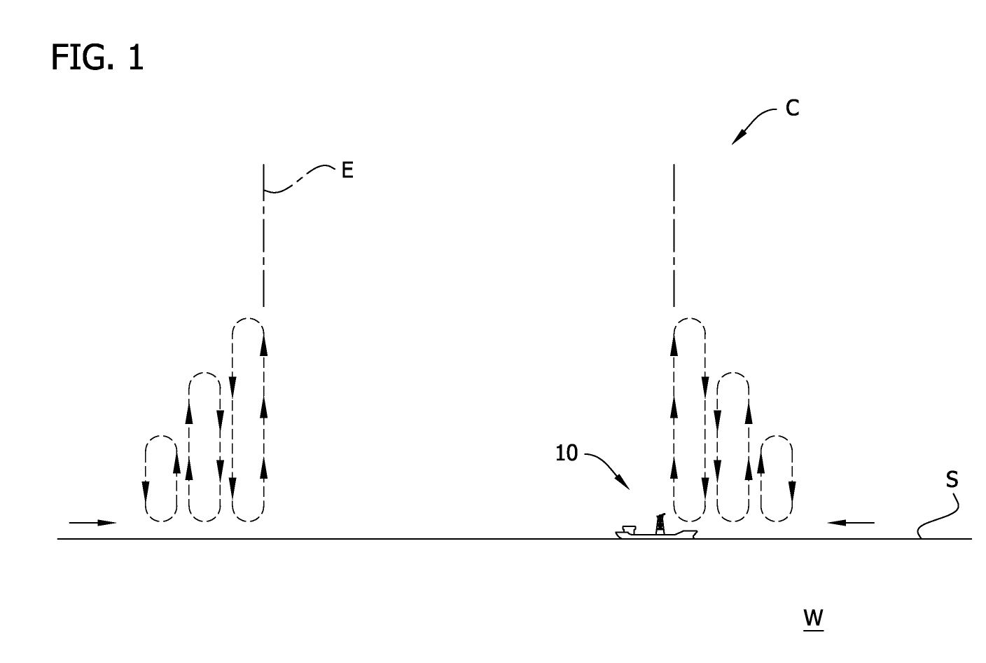

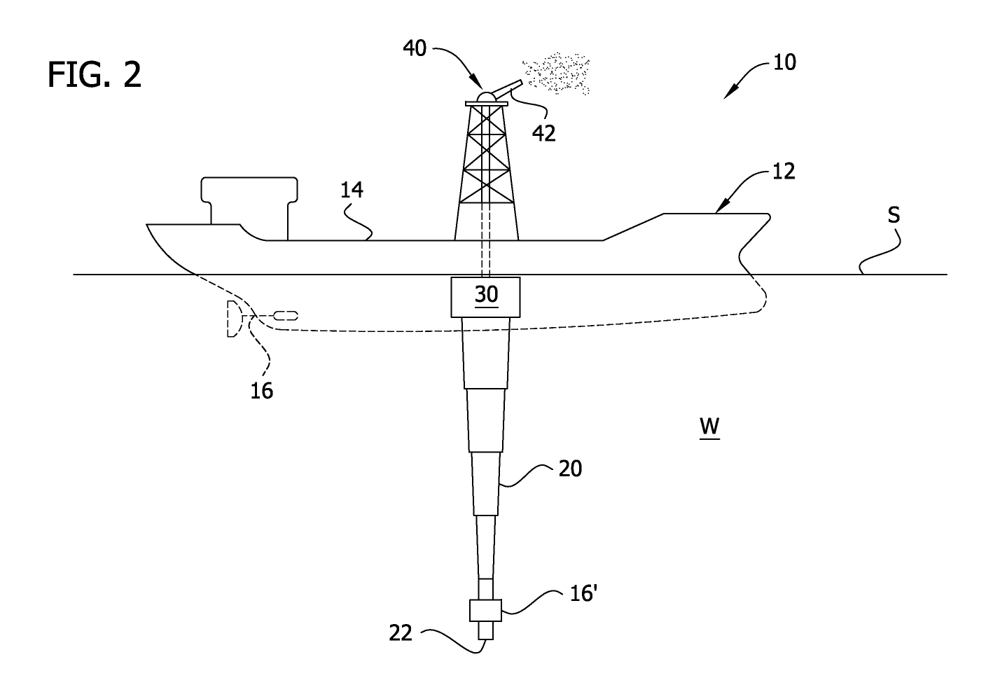

Referring to FIG. 2, apparatus for reducing intensity of a cyclone over water is designated generally by the reference number 10. In one embodiment, the apparatus 10 includes a ship, generally designated by 12, having a body 14 adapted to float in water and a propulsion system 16 mounted on the body having power sufficient to move the body through the water at a speed equivalent to that of a cyclone C (FIG. 1) so the ship 12 stays in a vicinity of an eyewall E of the cyclone. In one embodiment, the propulsion system 16 can move the body 12 at a speed of at least about thirty miles per hour. For example, the propulsion system 16 may include a propeller driven by a gas turbine or diesel engine. The body 14 has buoyancy sufficient to float in a fluid. In one embodiment, the buoyancy is sufficient to float in sea water W. As the features of a ship of the type used in this apparatus are well known to those skilled in the art, the ship 12 will not be described in further detail.

A conduit 20 extends downward from the body 14 of the ship 12 into the water W. The conduit 20 extends downward to an inlet 22. Although the inlet 22 may be at other depths without departing from the scope of the present invention, in one embodiment the inlet depth is more than about 250 feet below a surface S of the water W. In one embodiment, the inlet 22 has a depth in a range from about 250 feet to about 500 feet. Although the water at the inlet 22 may have other temperatures without departing from the scope of the present invention, in one embodiment the water at the inlet has a temperature of at least forty degrees Fahrenheit below that of water at the surface S. Although the conduit 20 may have other configurations, such as being a flexible hose, without departing from the scope of the present invention, in one embodiment the conduit is a telescopic rigid pipe that may be retracted when not in use. Further, the telescopic pipe may be extended and retracted to change the depth of the inlet 22. The conduit 20 may include an auxiliary propulsion system 16′ for driving the conduit through the water W.

The apparatus 10 also includes one or more pumps 30 in fluid communication with the conduit 20 for drawing water through the inlet 22 and upward through the conduit. In one embodiment, the apparatus 10 includes one pump 30 mounted on the body 14 of the ship 12. The pump 30 is selected to have sufficient power to draw water through the conduit 20 from the inlet 22. In some embodiments, auxiliary pumps (not shown) are spaced along the conduit 20 to assist in drawing water through the conduit. The apparatus 10 may also include filtering systems (not shown) to remove solids from the water traveling through the conduit 20.

As further shown in FIG. 2, the apparatus 10 includes a sprayer, generally designated by 40, operatively connected to the pump 30 and mounted on the ship 12 for spraying droplets of water drawn from the depth into rising air at the eyewall E of the cyclone C. Although other types of sprayers 40 may be used without departing from the scope of the present invention, in one embodiment the sprayer includes an atomizing spray nozzle 42 having an orifice sized for spraying droplets of a size sufficient to rise with rising air at an eyewall E of the cyclone C. The air at the eyewall E has the highest rotational velocity and vertical speed. Therefore, the eyewall is an optimal location for introducing cooling water into the cyclone. Further, the droplets are sized so that their terminal downward velocity due to gravity is less than a velocity of the rising air mass. This sizing results in minimal water falling back to the water before its thermal energy is transferred to the cyclone. Thus, cooling is maximized. As will be apparent to those skilled in the art, a plurality of nozzles may be present in a single apparatus to increase droplet distribution.

When using the apparatus 10 described above to reduce intensity of a cyclone C over water, water from a depth where the water has a temperature of at least forty degrees Fahrenheit below that of water at the surface. In some embodiments, the water has a temperature in a range from about forty degrees Fahrenheit to about fifty degrees Fahrenheit or more below that of the water at the surface. In some embodiments, the water is drawn from a depth of at least 250 feet. The water is drawn from a depth in some embodiments in a range from about 300 feet to about 500 feet. The water drawn from the depth is sprayed as atomized water into rising air above the water at the eyewall of the cyclone. As the cyclone moves, the propulsion system moves the ship to stay at the eyewall. Over time, introducing the colder water droplets into the rising air will cool the air mass and reduce the energy availably to the cyclone. Reducing the available energy results in reducing the intensity of the cyclone. In some instances, it is envisioned that prolonged application over several days will be required to accomplish the desired effect.

Other variants are envisioned as being within the scope of the present invention. For example, several apparatus 10 may deployed in a fleet of ships or in a stationary group of platforms spaced at sea. Further, rather than having conventional ocean going surface ships, airships and submersibles are also envisioned as falling within the scope of the present invention.

The term cyclone as used throughout this document is intended to include tropical storms, tropical cyclones, typhoons, and hurricanes.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

1. Apparatus for reducing intensity of a cyclone over water comprising:
a body having buoyancy sufficient to float in a fluid;
a conduit extending from the body into water to an inlet at a depth where the water has a temperature of at least forty degrees Fahrenheit below that of water at the surface;
a pump in fluid communication with the conduit for drawing water from the depth; and
a sprayer operatively connected to the pump for spraying droplets of water drawn from the depth, the sprayer being positioned and oriented for spraying the droplets of water into air moving in an upward direction above the water.

2. Apparatus as set forth in claim 1 further comprising a propulsion system mounted on the body having power sufficient to move the body through the water at a speed equivalent to that of the cyclone.

3. Apparatus as set forth in claim 1 wherein the body has buoyancy sufficient for floating at the surface of the water.

4. Apparatus as set forth in claim 1 wherein the pump is housed in the body.

5. Apparatus as set forth in claim 1 wherein the sprayer comprises an atomizing spray nozzle having an orifice sized for spraying droplets of a size sufficient to rise with rising air at an eyewall of the cyclone into air.

6. Apparatus for reducing intensity of a cyclone over water comprising:
a body having buoyancy sufficient to float in a fluid;
a conduit extending from the body into the water to an inlet at a depth of at least 250 feet;
a pump in fluid communication with the conduit for drawing water from the depth; and
a sprayer operatively connected to the pump for spraying droplets of water drawn from the depth, the sprayer being positioned and oriented for spraying the droplets of water into air flowing freely in open atmosphere above the water.

7. Apparatus as set forth in claim 6 further comprising a propulsion system mounted on the body having power sufficient to move the body through the water at a speed equivalent to that of the cyclone.

8. Apparatus as set forth in claim 6 wherein the body has buoyancy sufficient for floating at the surface of the water.

9. Apparatus as set forth in claim 6 wherein the pump is housed in the body.

10. Apparatus as set forth in claim 6 wherein the sprayer comprises an atomizing spray nozzle having an orifice sized for spraying droplets of a size sufficient to rise with rising air at an eyewall of the cyclone into air.

11. Apparatus for reducing intensity of a cyclone over water comprising:
a ship having a body adapted to float in water and a propulsion system mounted on the body having power sufficient to move the body through the water at a speed of at least thirty miles per hour;
a conduit extending from the body of the ship into the water to an inlet at a depth of at least 250 feet;
a pump in fluid communication with the conduit for drawing water from the depth; and
a sprayer mounted on the ship and operatively connected to the pump for spraying droplets of water drawn from the depth, the sprayer being positioned and oriented for spraying the droplets of water into rising air flowing free from any enclosure above the water.

12. Apparatus as set forth in claim 11 wherein the sprayer comprises an atomizing spray nozzle having an orifice sized for spraying droplets of a size sufficient to rise with rising air at an eyewall of the cyclone into air.

13. A method for reducing intensity of a cyclone over water comprising:
drawing water from a depth where the water has a temperature of at least forty degrees Fahrenheit below that of water at the surface; and
spraying water drawn from the depth into rising air above the water at an eyewall of the cyclone.

14. A method for reducing intensity of a cyclone over water comprising:
drawing water from a depth of at least 250 feet;
atomizing the water drawn from the depth into droplets of a size sufficient to rise with rising air at an eyewall of the cyclone; and
introducing the atomized water into rising air above the water at an eyewall of the cyclone.

15. A method as set forth in claim 13 wherein spraying water into rising air above the water includes spraying water into air flowing freely in open atmosphere.

16. A method as set forth in claim 14 wherein introducing the atomized water into rising air above the water includes introducing the atomized air into air flowing free from any enclosure.
